(19) United States
(12) Patent Application Publication
(10) Pub. No.: US 2010/0108106 A1
(43) Pub. Date: May 6, 2010

(54) SUBSTRATE CLEANING APPARATUS

(76) Inventors: Norikazu Hoshi, Osaka (JP); Masato Tanaka, Kyoto (JP)

Correspondence Address: OSTROLENK FABER GERB & SOFFEN, 1180 AVENUE OF THE AMERICAS, NEW YORK, NY, 100368403, US

(21) Appl. No.: 12/529,875

(22) PCT Filed: Feb. 27, 2008
(86) PCT No.: PCT/JP2008/053408

§ 371 Date: Sep. 3, 2009

(30) Foreign Application Priority Data
Mar. 5, 2007 (JP) 2007-053984

(51) Int. Cl. B08B 3/00

(52) U.S. Cl. 134/95.1

(57) ABSTRACT

A chemical solution is mixed to deionized water from a chemical cartridge 29 via a chemical supply unit 27 to produce a treating liquid. Then, the treating liquid is supplied to a treating tank via a supply pipe. The chemical cartridge 29 is not supplemented with the chemical solution through a supplementing line etc., and the chemical solution is not contaminated. As a result, cleanliness of the chemical solution can be kept high, and substrates can be cleaned at a high clean level. Moreover, the chemical cartridge 29 also has a residual quantity display portion 39. Thus a residual quantity of the chemical solution in the chemical cartridge 29 can easily be recognized, and periodic replacement timing of the chemical cartridge 29 can be recognized easily. Furthermore, the chemical cartridge 29 can control the flow rate by a nozzle portion 47. Consequently, the chemical cartridge 29 can directly be attached to the supply pipe, which can simplify the construction and thus can reduce apparatus cost.

### TECHNICAL FIELD

This invention relates to a substrate cleaning apparatus for cleaning substrates such as semiconductor wafers and glass substrates for liquid crystal displays (hereinafter called simply “substrates”) with a treating liquid.

### BACKGROUND ART

The apparatus of this type conventionally includes a treating unit for storing a treating liquid, a supply pipe for supplying deionized water to the treating unit, a mixing valve for mixing a chemical solution to the deionized water flowing through the supply pipe, a branch pipe for supplying the chemical solution to the mixing valve, and a chemical tank connected in communication with the branch pipe. See, for example, Patent Document 1. In the substrate cleaning apparatus with such a configuration, the chemical solution (for example, hydrofluoric acid) stored in the chemical tank is mixed into the deionized water from the mixing valve to perform a cleaning treatment to the substrates accommodated in the treating unit.

Patent Document 1: Japanese Unexamined Patent Publication H11-67707A.

### SUMMARY OF THE INVENTION

### Problem to be Solved by the Invention

The conventional apparatus having such a configuration, however, have the following drawback. That is, deionized water has extremely high cleanliness in ppt-level, and substrates are rarely contaminated due to the deionized water. On the other hand, a chemical solution has lower cleanliness than deionized water, and thus substrates may be contaminated due to the chemical solution. Specifically, in supplementing the chemical solution to the chemical tank through the chemical supply line, particles may be mixed through the supplementing line, or a metal ion may be eluted and mixed into the chemical solution, thereby reducing cleanliness of the chemical solution. As a result, the substrates can never be cleaned at a high clean level even using the deionized water with high cleanliness for cleaning.

This invention has been made in view of the state of the art noted above, and its object is to provide a substrate cleaning apparatus capable of cleaning substrates at a high clean level by improving cleanliness of a chemical solution.

### Means for Solving the Problem

This invention has a following configuration in order to achieve the above object. The apparatus of this invention is an apparatus for cleaning substrates with a treating liquid containing a chemical solution, including:

a treating unit for treating the substrates with the treating liquid;

a supply pipe for supplying deionized water to the treating unit;

a chemical supply unit for supplying the chemical solution to the supply pipe; and

a chemical cartridge for storing the chemical solution and removable from the chemical supply unit.

According to this invention, a chemical solution is mixed with deionized water from the chemical cartridge via the chemical supply unit to produce a treating liquid. Then, the treating liquid is supplied to the treating unit via the supply pipe. The chemical cartridge is not supplemented with the chemical solution through the supplementing line etc., and the chemical solution is not contaminated. As a result, cleanliness of the chemical solution can be kept high, and the substrates can be cleaned at a high clean level.

Moreover, the chemical cartridge in this invention preferably includes a controller for controlling a supply flow rate of the chemical solution. Furthermore, the chemical supply unit preferably includes an attachment portion to which the chemical cartridge can be attached.

According to this invention, the chemical cartridge can be directly attached to the supply pipe by attaching the chemical cartridge capable of controlling a flow rate of the chemical solution with the controller to the attachment portion, which can simplify the construction and can reduce apparatus cost.

Furthermore, the chemical supply unit in this invention preferably includes a mixing valve for mixing the chemical solution. The mixing valve preferably has a branch pipe through which the chemical solution is supplied. The branch pipe preferably has an attachment portion to which the chemical cartridge can be attached.

According to this invention, the chemical cartridge is attached to the attachment portion and the chemical solution is supplied to the mixing valve through the branch pipe. Thus, the mixing valve can supply a desired flow rate of the chemical solution to the deionized water. In addition, it only needs to provide the attachment portion on the branch pipe of the mixing valve included in the conventional apparatus. Consequently, a chemical cartridge system is easily applicable to the conventional apparatus.

Furthermore, the chemical cartridge in this invention preferably includes a residual quantity detecting sensor for detecting a quantity of the chemical solution currently stored inside.

According to this invention, replacement timing of the chemical cartridge can be easily recognized.

Furthermore, the chemical cartridge in this invention is preferably filled in advance with a hydrochloric acid solution produced by dissolving a hydrogen chloride gas in deionized water.

According to this invention, the hydrogen chloride gas is dissolved in the deionized water, thereby producing the hydrochloric acid solution with high cleanliness. Thus, there can be prevented reduction in cleanliness of the chemical solution during use.

Furthermore, the chemical cartridge in this invention is preferably filled in advance with an ammonia solution produced by dissolving an ammonia gas in deionized water.

According to this invention, the ammonia gas is dissolved in the deionized water, thereby producing the ammonia solution with high cleanliness. Thus, there can be prevented reduction in cleanliness of the chemical solution during use.

Furthermore, the chemical cartridge in this invention is preferably filled in advance with a hydrofluoric acid solution produced by dissolving a hydrogen fluoride gas in deionized water.

According to this invention, the hydrogen fluoride gas is dissolved in the deionized water, thereby producing the hydrofluoric acid solution with high cleanliness. Thus, there can be prevented reduction in cleanliness of the chemical solution during use.

### EFFECT OF THE INVENTION

With the substrate cleaning apparatus according to this invention, the chemical solution is mixed with deionized water from the chemical cartridge via the chemical supply unit to produce the treating liquid. Then, the treating liquid is supplied to the treating unit via the supply pipe. The chemical cartridge is not supplemented with the chemical solution through the supplementing line etc., and the chemical solution is not contaminated. As a result, cleanliness of the chemical solution can be kept high, and the substrates can be cleaned at a high clean level.

### BRIEF DESCRIPTION OF THE DRAWINGS

For the purpose of illustrating the invention, there are shown in the drawings several forms presently preferred, it being understood, however, that the invention is not limited to the precise arrangement and instrumentalities shown.

FIG. 1 is a schematic view of a substrate cleaning apparatus according to Embodiment 1;

FIG. 2 is a longitudinal sectional schematic view of a chemical cartridge; and

FIG. 3 is a schematic view of a substrate cleaning apparatus according to Embodiment 2.

### DESCRIPTION OF REFERENCES

W substrate

1 treating tank

7 inner tank

9 outer tank

11 filling pipe

17 supply pipe

19 deionized water source

21 ozone water source

27 chemical source

29 chemical cartridge

37 cartridge body

39 residual quantity display portion

41 outer container

43 inner container

45 insert portion

47 nozzle portion

53 attachment portion

57 inlet

### EMBODIMENT 1

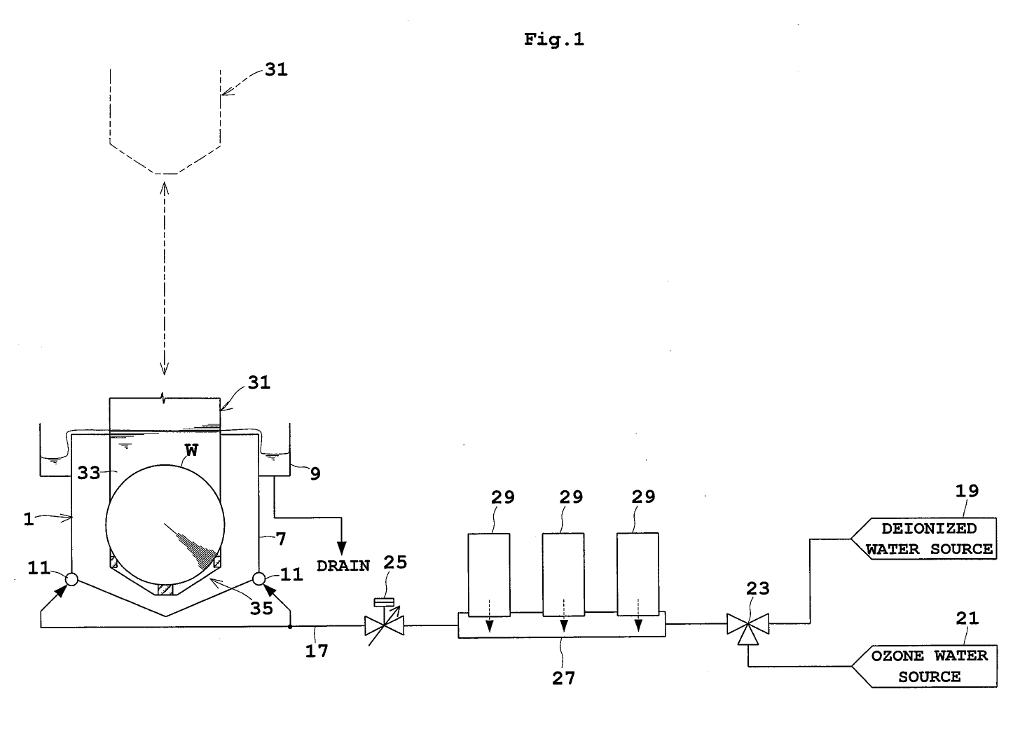

Embodiment 1 of this invention will be described in detail hereinafter with reference to the drawings. FIG. 1 is a schematic view of a substrate cleaning apparatus according to Embodiment 1.

The substrate cleaning apparatus of this embodiment is for instant an apparatus for performing a cleaning treatment to substrates W, and includes a treating tank 1 corresponding to the treating unit of this invention. The treating tank 1 has an inner tank 7 that stores a treating liquid while accommodating the substrates W, and an outer tank 9. The inner tank 7 has one pair of filling pipes 11 on both sides of its bottom for supplying the treating liquid. The outer tank 9 encloses the lateral sides of an upper opening of the inner tank 7, and collects and discharges the treating liquid overflowing the inner tank 7.

One end of a supply pipe 17 is connected in communication with the filling pipes 11 of the treating tank 1. The other end of the supply pipe 17 is connected in communication with a deionized water source 19 and an ozone water source 21 via a three-way valve 23. The supply pipe 17 between the filling pipes 11 and the three-way valve 23 has a control valve 25 and a chemical supply unit 27 attached thereto. The chemical supply unit 27 has two or more types of removable chemical cartridges 29, and supplies a proper chemical solution into the supply pipe 17 depending on treatments.

A substrate holding mechanism 31 includes a back plate 33 and a substrate holding guide 35. The back plate 33 with a plate-like member is attached to a transport mechanism, not shown, in a suspended attitude. The back plate 33 can move vertically along the inner wall surface of the inner tank 7. The substrate holding guide 35 for holding two or more substrates W in an erect attitude is attached on the front lower end of the back plate 33 with the longitudinal direction of the substrate holding guide 35 being horizontal. The substrate holding mechanism 31 is vertically movable between a treating position inside the inner tank 7 and a standby position above the inner tank 7 by a lifting mechanism not shown.

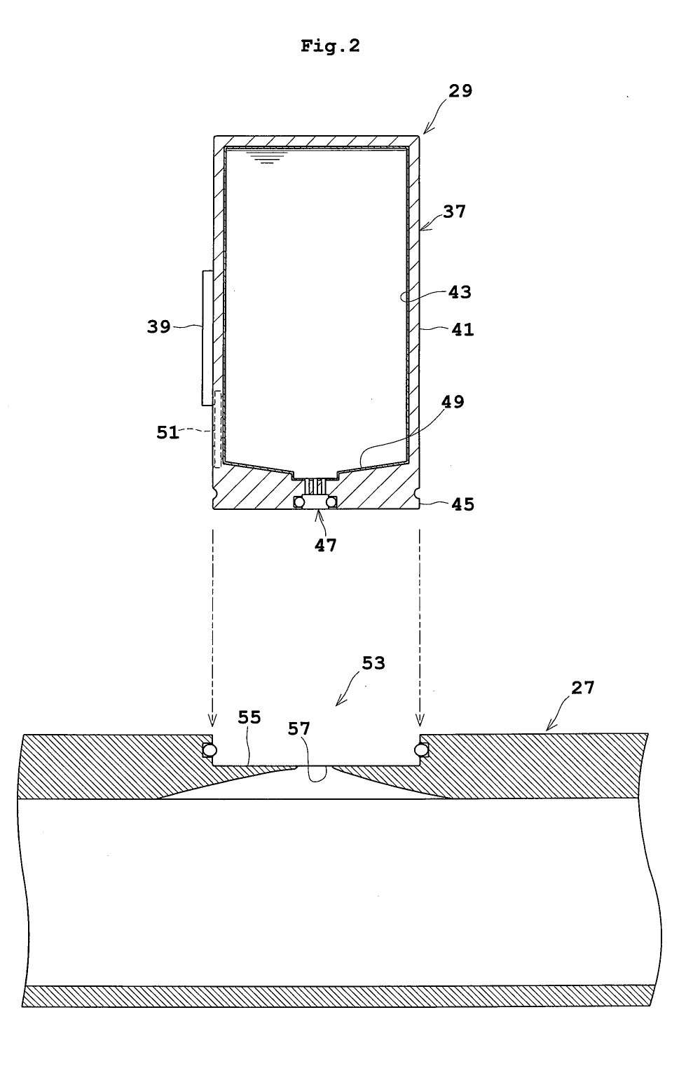

Reference is now made to FIG. 2. FIG. 2 is a longitudinal sectional schematic view of the chemical cartridge.

The chemical cartridge 29 includes a cartridge body 37 and a residual quantity display portion 39. The cartridge body 37 has an outer container 41, an inner container 43, an insert portion 45, and a nozzle portion 47.

The outer container 41 has a bottom 49 so as to form downward inclines toward the nozzle portion 47, whereby the chemical solution hardly remains in the chemical cartridge. The inner container 43 is made from a material resistant to the chemical solution to be stored. The material is, for example, fluororesin, polypropylene, polyethylene, vinylidene chloride, etc.

The nozzle portion 47 corresponding to the controller of this invention has two or more outlets. Properly opening and closing of these outlets can control a supply rate of the chemical solution. The control unit not shown performs the above control.

A liquid level sensor 51 is embedded adjacent to the bottom 49 of the outer container 41. The liquid level sensor 51 detects a level of the liquid in the inner container 43, and outputs the resultant signal to the residual quantity display portion 39. The residual quantity display portion 39 displays a quantity of the chemical solution currently stored in response to the signal. Here, the residual quantity display portion 39 and the liquid level sensor 51 correspond to the residual quantity detecting sensor of this invention.

The chemical supply unit 27 has at its top an attachment portion 53 to which the chemical cartridge 29 is attached. The attachment portion 53 formed at the top of the chemical supply unit 27 includes a recess 55 slightly larger than the outer shape of the insert portion 45 of the chemical cartridge 29, and an inlet 57 formed on the bottom of the recess 55 and positioned corresponding to the nozzle portion 47.

The insert portion 45 of the chemical cartridge 29 mentioned above is inserted into the attachment portion 53 to be in service.

The chemical cartridge 29 mentioned above is, for example, filled in advance under a clean environment with a hydrochloric acid solution produced by dissolving a hydrogen chloride gas in deionized water, filled in advance under a clean environment with an ammonia solution produced by dissolving an ammonia gas in deionized water, or filled in advance under a clean environment with a hydrofluoric acid solution produced by dissolving a hydrogen fluoride gas in deionized water. Thus, a treating liquid with high cleanliness can be produced, thereby avoiding reduction in cleanliness of the treating solution during use.

Next, description will be made of a cleaning treatment with the substrate cleaning apparatus mentioned above. Here, the chemical cartridge 29 filled with a hydrofluoric acid solution and the chemical cartridge 29 filled with a container with hydrochloric acid are attached to the attachment portions 53 of the chemical supply unit 27.

The hydrofluoric acid solution from the chemical cartridge 29 is mixed to the deionized water with the deionized water being supplied to the supply pipe 17 at a specified flow rate from the deionized water source 19, and is supplied to the inner tank 7 as a treating liquid. Subsequently, the substrates W move downward to a treatment position with the treating liquid overflowing the inner tank 7. This state is then maintained for a predetermined time. Subsequently, supply of the hydrofluoric acid solution from the chemical cartridge 29 is stopped to perform cleaning with the deionized water. After elapse of a predetermined time, supply of the deionized water from the deionized water source 19 is stopped while the ozone water is supplied at a specified flow rate from the ozone water source 21. This state is maintained for a predetermined time, and then the deionized water is supplied again only from the deionized water source 19 to perform cleaning with the deionized water. In addition, the hydrochloric acid solution is supplied at a specified flow rate from the chemical cartridge 29 storing the hydrochloric acid solution, and this state is maintained for a predetermined time. Subsequently, supply of the hydrochloric acid solution from the chemical cartridge 29 is stopped, and only the deionized water is supplied from the deionized water source 19 to perform cleaning with the deionized water. After finishing final cleaning with the deionized water, the substrates W in the treatment position are pulled up from the inner tank 7 to move into a standby position.

With the apparatus of this embodiment mentioned above, the chemical solution is mixed to the deionized water from the chemical cartridge 29 via the chemical supply unit 27 to produce the treating liquid. Then, the treating liquid is supplied to the treating tank 1 via the supply pipe 17. The chemical cartridge 29 is not supplemented with the chemical solution through the supplementing line etc., and the chemical solution is not contaminated. As a result, cleanliness of the chemical solution can be kept high, and the substrates can be cleaned at a high clean level.

The chemical cartridge 29 also has a residual quantity display portion 39. Thus a residual quantity of the chemical solution in chemical cartridge 29 can easily be recognized, and periodic replacement timing of the chemical cartridge 29 can also be recognized easily. In addition, the chemical cartridge 29 can control the flow rate by the nozzle portion 47. Consequently, the chemical cartridge 29 can directly be attached to the supply pipe 17, which can simplify the construction and thus can reduce apparatus cost.

### EMBODIMENT 2

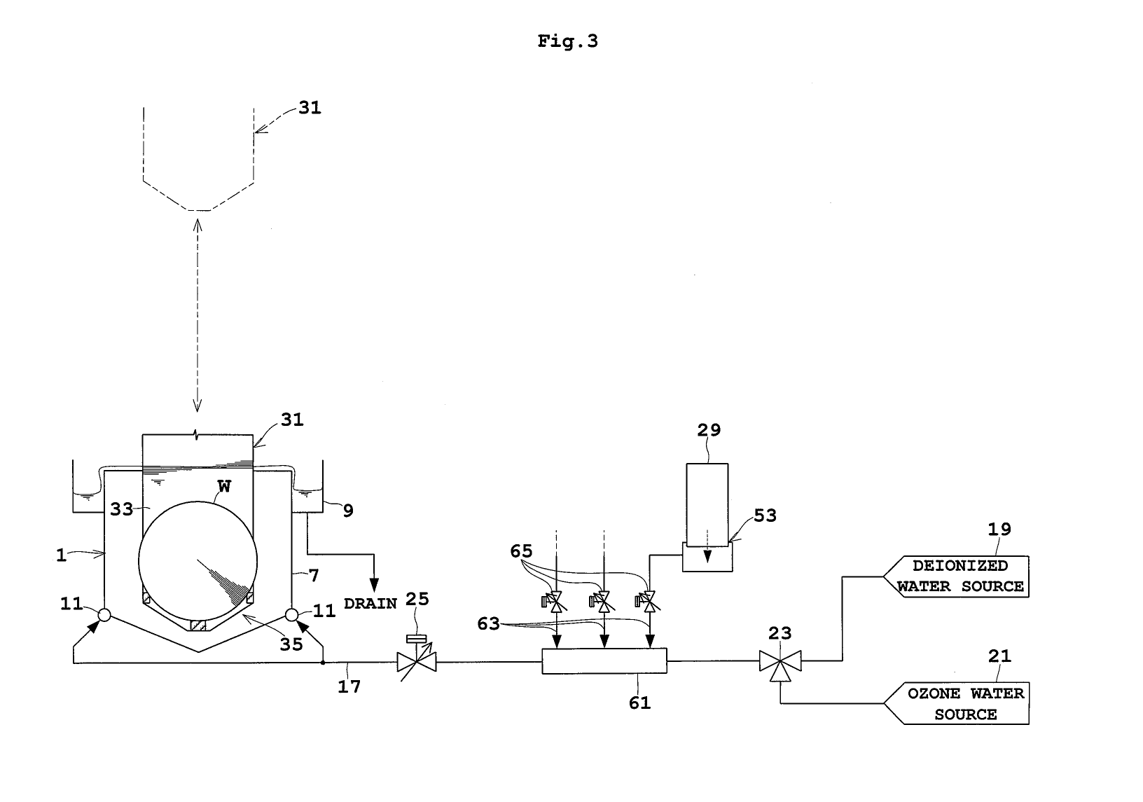

Description will be next given to Embodiment 2 of this invention with reference to the drawings. FIG. 3 is a schematic view of a substrate treating apparatus according to Embodiment 2. The same elements as in Embodiment 1 mentioned above are represented by the same numerals, and the detailed description of such elements will be omitted.

The supply pipe 17 has a mixing valve 61. The mixing valve 61 includes two or more branch pipes 63 through which a chemical solution is supplied. Each branch pipe 63 is provided with a control valve 65 for controlling a flow rate. Each branch pipe 63 has an attachment portion 53 at its end from which the chemical cartridge 29 is removable.

With the configuration in Embodiment 2, the control valve 65 controls a flow rate. Consequently, the chemical cartridge 29 may be attached to the attachment portion 53 with the nozzle portion 47 full open. Moreover, in Embodiment 2, treatment to the substrates W is performed as in Embodiment 1 mentioned above, but the control valve 65 controls the flow rate of the chemical solution.

According to the apparatus of this embodiments, it just needs to provide the attachment portion 53 on the branch pipe 63 of the mixing valve 61 included in the conventional apparatus. Consequently, the chemical cartridge system according to this invention is easily applicable to the conventional apparatus.

This invention is not limited to the foregoing embodiment, but may be modified as follows.

(1) In each embodiment mentioned above, a so-called batch type apparatus has been described as one example in which the treating tank 1 is provided as a treating unit and the substrates W are immersed therein. This invention is also applicable to apparatus of so-called single wafer type that perform treatment to one substrate W at a time. Specifically, there is included an apparatus that holds substrates in a horizontal attitude as a treating unit and that has a rotating member pivotal in a horizontal plane and supplies a treating liquid from a nozzle arranged above the rotating member to perform a cleaning treatment for every one substrate.

(2) This invention is not limited to the configuration of the chemical cartridge 29 in each embodiment mentioned above, but may have any shapes and structures removable from the chemical supply unit and filled with a chemical solution under a clean environment.

(3) In each embodiment mentioned above, a cleaning treatment has been described as one example with a hydrofluoric acid solution, deionized water, ozone water, deionized water, a hydrochloric acid solution, and deionized water. This invention is also applicable to cleaning treatments other than this cleaning treatment.

(4) Each embodiment mentioned above has been described with three chemical cartridges 29. One chemical cartridge 29 or four or more chemical cartridges 29 may be applied to this invention.

1. A substrate cleaning apparatus for cleaning substrates with a treating liquid containing a chemical solution, comprising:
a treating unit for treating the substrates with the treating liquid;
a supply pipe for supplying deionized water to the treating unit;
a chemical supply unit for supplying the chemical solution to the supply pipe; and
a chemical cartridge for storing the chemical solution and removable from the chemical supply unit.

2. The substrate cleaning apparatus according to claim 1, wherein
the chemical cartridge comprises a controller for controlling a supply flow rate of the chemical solution,; and
the chemical supply unit comprises an attachment portion to which the chemical cartridge can be attached.

3. The substrate cleaning apparatus according to claim 1, wherein
the chemical supply unit comprises a mixing valve for mixing the chemical solution; and
the mixing valve comprises a branch pipe through which the chemical solution is supplied, and the branch pipe comprises an attachment portion to which the chemical cartridge can be attached.

4. The substrate cleaning apparatus according to claim 1 any u
the chemical cartridge comprises a residual quantity detecting sensor for detecting a quantity of the chemical solution currently stored inside.

5. The substrate cleaning apparatus according to claim 1, wherein
the chemical cartridge is filled in advance with a hydrochloric acid solution produced by dissolving a hydrogen chloride gas in deionized water.

6. The substrate cleaning apparatus according to claim 1, wherein
the chemical cartridge is filled in advance with an ammonia solution produced by dissolving an ammonia gas in deionized water.

7. The substrate cleaning apparatus according to claim 1, wherein
the chemical cartridge is filled in advance with a hydrofluoric acid solution produced by dissolving a hydrogen fluoride gas in deionized water.

8. The substrate cleaning apparatus according to claim 2, wherein
the chemical cartridge comprises a residual quantity detecting sensor for detecting a quantity of the chemical solution currently stored inside.

9. The substrate cleaning apparatus according to claim 3, wherein
the chemical cartridge comprises a residual quantity detecting sensor for detecting a quantity of the chemical solution currently stored inside.
